(19) United States
(12) Patent Application Publication
(10) Pub. No.: US 2022/0319352 A1
(43) Pub. Date: Oct. 6, 2022

(54) Automatically Entering A Demonstration Mode For A Device Based On Audio Conversation

(71) Applicant: Motorola Mobility LLC, Chicago, IL (US)

(72) Inventors: Mayank Rajesh Gupta, Naperville, IL (US); Nadeem Nazarali Panjwani, Chicago, IL (US); Amit Kumar Agrawal, Bangalore (IN)

(73) Assignee: Motorola Mobility LLC, Chicago, IL (US)

(21) Appl. No.: 17/220,781

(22) Filed: Apr. 1, 2021

(51) Int. Cl. G09B 19/00; H04M 1/72448; G10L 15/18

(52) U.S. Cl. CPC G09B 19/0053; H04M 1/72448; G10L 15/1815

(57) ABSTRACT

A demonstration mode control system of a device receives and analyzes audio at the device. This audio includes, for example, a conversation between two or more users, such as an owner of the device and another (secondary) user. The system analyzes the conversation and determines whether a user intent is to have a secondary user of the device assess features of the device. In response to determining that the user intent is to have the secondary user assess the features of the device, the system automatically enters a demonstration mode for the device including running a demonstration program that highlights features of the device. The demonstration mode optionally includes changing device property values for the device to demonstration mode device property values that are expected to best demonstrate capabilities of the device.

### BACKGROUND

As technology has advanced, people have become increasingly reliant upon a variety of different computing devices, such as wireless devices (e.g., wireless phones or tablets). While these computing devices offer a variety of different benefits, they are not without their problems. One such problem is that oftentimes users share their devices with other users, such as family members, friends, or co-workers. In such situations the other users may be unfamiliar with the device or its capabilities, and may be unaware of how the device is different from other similar devices they have previously used and may be unfamiliar with various features of the device that are available to the user. This can lead to user dissatisfaction and frustration with the devices by the other users with which a device is shared.

### BRIEF DESCRIPTION OF THE DRAWINGS

Embodiments of automatically entering a demonstration mode for a device on a computing device are described with reference to the following drawings. The same numbers are used throughout the drawings to reference like features and components:

FIG. 1 illustrates an example computing device implementing the techniques discussed herein;

FIG. 2 illustrates an example architecture of the demonstration mode control system;

FIG. 3 illustrates an example of demonstration mode content;

FIG. 4 illustrates an example of changing device property values;

FIG. 5 illustrates an example process for implementing the techniques discussed herein in accordance with one or more embodiments; and

FIG. 6 illustrates various components of an example electronic device that can implement embodiments of the techniques discussed herein.

### DETAILED DESCRIPTION

Automatically entering a demonstration mode for a device based on audio conversation is discussed herein. A demonstration mode control system of a device receives and analyzes audio at the computing device. This audio includes, for example, a conversation between two or more users present at the device, such as an owner of the device and another (secondary) user. The demonstration mode control system analyzes the conversation between the two or more users and determines whether a user intent is to have a secondary user of the device assess features of the device. This user intent can be an intent of one or more of the two or more users in the conversation. In response to determining that the user intent is to have the secondary user assess the features of the device, the system automatically enters a demonstration mode for the device including running a demonstration program that highlights features of the device. The demonstration mode optionally includes changing device property values for the device to demonstration mode device property values that are expected to best demonstrate capabilities of the device.

The techniques discussed herein improve usability of the device. The device is automatically changed to a demonstration mode in response to determining that the user intent is to have a secondary user assess features of the device. In the demonstration mode a demonstration program is run highlighting the features of the device, alleviating the secondary user of needing to determine for himself what the features of the device are. Furthermore, the device is changed to the demonstration mode automatically, alleviating the users from manually inputting commands to the device to enter the demonstration mode.

Furthermore, the techniques discussed herein allow the device property values to be automatically set as part of the demonstration mode (and thus in response to determining that the user intent is to have a secondary user assess features of the device) to values that are expected to best demonstrate the capabilities of the device. This ensures that a secondary user that is potentially unfamiliar with the device is able to have a good experience using the device and need not expend time or resources (e.g., battery life) attempting to navigate through various different settings screens that the secondary user is unfamiliar with, reducing the initial friction for the secondary user caused due to device property values set by the owner.

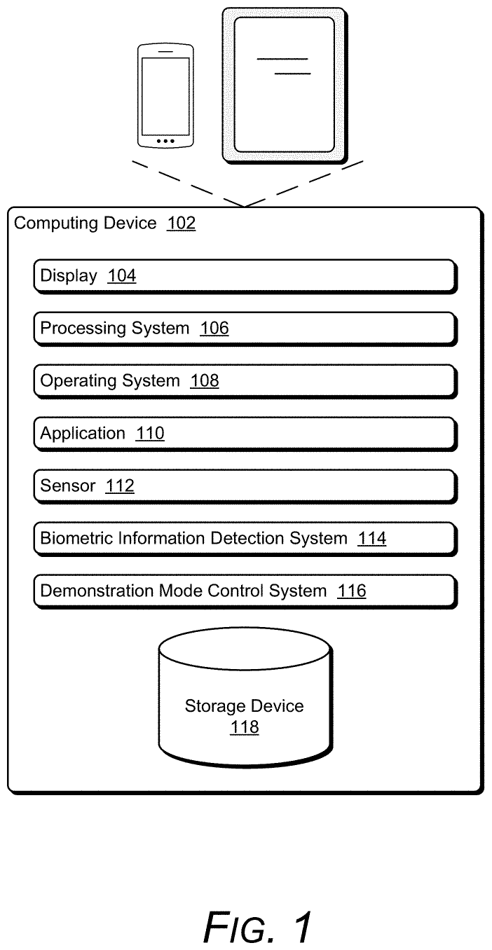

FIG. 1 illustrates an example computing device 102 implementing the techniques discussed herein. The computing device 102 can be, or include, many different types of computing or electronic devices. For example, the computing device 102 can be a smartphone or other wireless phone, a camera (e.g., compact or single-lens reflex), or a tablet or phablet computer. By way of further example, the computing device 102 can be a notebook computer (e.g., netbook or ultrabook), a laptop computer, a wearable device (e.g., a smartwatch, an augmented reality headset or device, a virtual reality headset or device), a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, an automotive computer, and so forth.

The computing device 102 includes a display 104. The display 104 can be configured as any suitable type of display, such as an organic light-emitting diode (OLED) display, active matrix OLED display, liquid crystal display (LCD), in-plane shifting LCD, projector, and so forth. Although illustrated as part of the computing device 102, it should be noted that the display 104 can be implemented separately from the computing device 102. In such situations, the computing device 102 can communicate with the display 104 via any of a variety of wired (e.g., Universal Serial Bus (USB), IEEE 1394, High-Definition Multimedia Interface (HDMI)) or wireless (e.g., Wi-Fi, Bluetooth, infrared (IR)) connections. The display 104 can also optionally operate as an input device (e.g., the display 104 can be a touchscreen display).

The computing device 102 also includes a processing system 106 that includes one or more processors, each of which can include one or more cores. The processing system 106 is coupled with, and may implement functionalities of, any other components or modules of the computing device 102 that are described herein. In one or more embodiments, the processing system 106 includes a single processor having a single core. Additionally or alternatively, the processing system 106 includes a single processor having multiple cores and/or multiple processors (each having one or more cores).

The computing device 102 also includes an operating system 108. The operating system 108 manages hardware, software, and firmware resources in the computing device 102. The operating system 108 manages one or more applications 110 running on the computing device 102, and operates as an interface between applications 110 and hardware components of the computing device 102.

The computing device 102 also includes at least one sensor 112. The sensor 112 can be any of a variety of different types of sensors, such as a fingerprint sensor (e.g., a capacitive scanner, an optical scanner, an ultrasonic scanner, etc.), an image sensor (e.g., a charge-coupled device (CCD) sensor or a complementary metal-oxide-semiconductor (CMOS) sensor), a touchscreen (e.g., as part of the display 104 on one or more surfaces of the computing device 102), and so forth. In one or more embodiments, the sensor 112 is an audio sensor (e.g., a microphone, such as any suitable type of microphone incorporating a transducer that converts sound into an electrical signal, including a dynamic microphone, a condenser microphone, a piezoelectric microphone, and so forth).

The computing device 102 also includes a biometric information detection system 114 and a demonstration mode control system 116. Each of the biometric information detection system 114 and the demonstration mode control system 116 can be implemented in a variety of different manners. For example, each of system 114 and 116 can be implemented as multiple instructions stored on computer-readable storage media and that can be executed by the processing system 106. Additionally or alternatively, each system 114 and 116 can be implemented at least in part in hardware (e.g., as an application-specific integrated circuit (ASIC), a field-programmable gate array (FPGA), and so forth). System 114 and 116 can each be implemented in the same manner, or each system 114 and 116 can be implemented in a different manner. Furthermore, although illustrated as separate from the operating system 108, one or more of the biometric information detection system 114 and the demonstration mode control system 116 can be implemented at least in part as part of the operating system 108.

Generally, the biometric information detection system 114 receives signals from the at least one sensor 112 and detects various biometric information regarding the current user of the computing device 102 in order to assist the demonstration mode control system 116 in recognizing the current user of the computing device 102. Various different biometric information can be detected by the biometric information detection system 114, such as voice information, face information, fingerprint information, grip information, and so forth.

In one or more embodiments, the current user of the computing device 102 is a user that is in possession of the computing device 102. A user being in possession of the computing device 102 refers to a user that is physically in control of or currently accessing the computing device 102. For example, the user that is holding the computing device 102 (e.g., with his or her hand) is the current user that is in possession of the computing device 102.

The biometric information detection system 114 detects various biometric information regarding the current user of the computing device 102. This biometric information can be, for example, information describing the user's voice, facial features, fingerprint features, grip on the computing device 102, and so forth. Any of a variety of different public or proprietary techniques can be used to obtain the biometric information, and the particular techniques implemented by the biometric information detection system 114 can vary based on the particular biometric information that is obtained by the biometric information detection system 114.

For example, facial features can be obtained from a current image captured by the sensor 112 and can include information regarding size and/or location of different aspects of a user's face, such as eyes, nose, mouth corners, ears, and so forth. By way of another example, fingerprint features can be obtained from the sensor 112 and can include information regarding the pattern of ridges or lines on one or more of the user's fingers. By way of another example, voice input can be captured by sensor 112 and can include information regarding different aspects of speech (e.g., phonemes) and the order and timing of the occurrence of those phonemes. By way of yet another example, touch features regarding how the user is touching or gripping the computing device 102 can be obtained from one or more sensors 112 that are touch sensors distributed around the computing device 102 (e.g., one or more pressure sensors, one or more capacitive sensors, one or more optical sensors, etc.) and can include information regarding the locations of the computing device 102 being touched by the user, an amount of force applied by the user in touching different locations of the computing device 102, and so forth.

The demonstration mode control system 116 receives from a sensor 112 (e.g., a microphone) audio data that includes a conversation between at least two people present at the computing device 102. The demonstration mode control system 116 analyzes the conversation and determines whether a user intent is to have a secondary user of the computing device assess features of the computing device 102. In response to determining that the user intent is to have the secondary user assess the features of the computing device, the demonstration mode control system 116 automatically causes the computing device 102 to enter a demonstration mode including running a demonstration program that highlights features of the computing device 102.

The computing device 102 also includes a storage device 118. The storage device 118 stores various data or instructions used by various systems or modules of the computing device 102. In one or more embodiments, the storage device 118 stores demonstration content to display while the computing device 102 is in demonstration mode as well as optionally other content as discussed in more detail below.

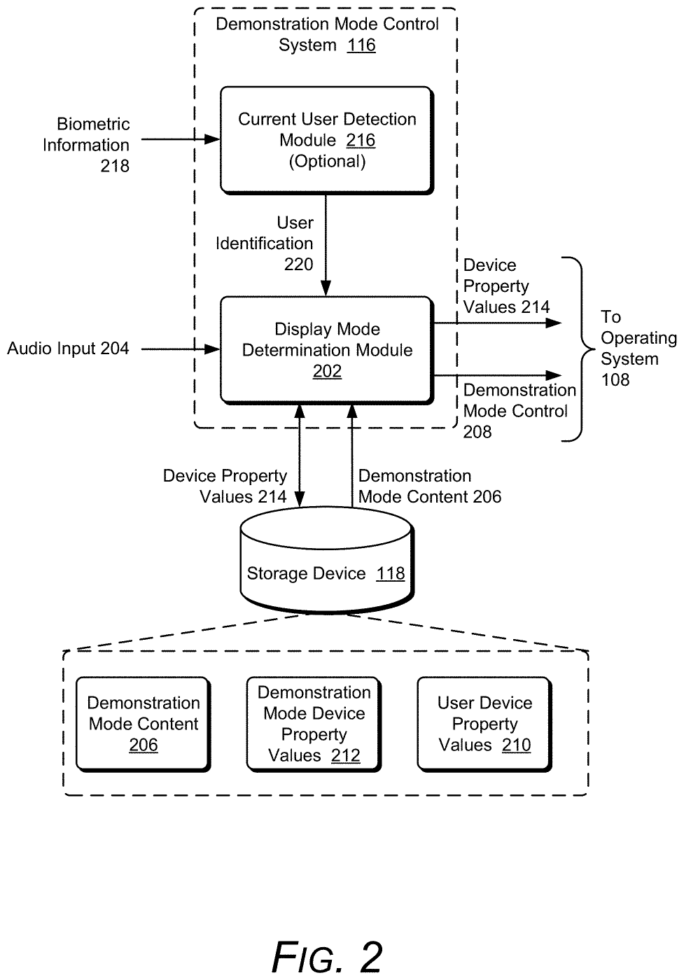

FIG. 2 illustrates an example architecture of the demonstration mode control system 116. The demonstration mode control system 116 includes a display mode determination module 202 that receives audio input 204, analyzes a conversation included in the audio input 204, and automatically causes the computing device 102 to enter a demonstration mode in response to determining from the conversation that a user intent is to have a secondary user of the computing device assess features of the computing device 102. Additionally or alternatively, the display mode determination module 202 also analyzes the conversation in the audio input 204 while the computing device 102 is operating in the demonstration mode and automatically causes the computing device 102 to exit the demonstration mode in response to determining that a user intent is to exit the demonstration mode.

The display mode determination module 202 receives audio input 204 from a microphone (e.g., a sensor 112). The audio input 204 includes audio data captured from one or more users present at the computing device 102 while the computing device 102 is in use, such as while the computing device 102 is unlocked, while the computing device 102 is being held by a user (e.g., based on grip or touch detection), and so forth. A user being present at the computing device 102 refers to a user within a threshold distance of the computing device 102, such as within range of a sensor 112 (e.g., a microphone, an image sensor), rather than a remote user (e.g., a user of a different device with which the computing device 102 is in a phone call). The display mode determination module 202 analyzes the audio input 204 to determine whether the intent of a user (e.g., a current user that is the owner or a secondary user of the computing device 102) whose voice is captured by the microphone is to have a secondary user assess features of the computing device 102.

The audio input 204 includes a conversation between at least two people present at the computing device 102. The display mode determination module 202 analyzes the conversation included in the audio input 204 to determine whether the intent of a user (one of the at least two people in the conversation) is to have a secondary user assess features of the computing device 102. The secondary user is typically, but need not be, one of the at least two people in the conversation.

The display mode determination module 202 determines whether the intent of a user is to have a secondary user assess or evaluate features of the computing device 102 based on the conversation between the at least two people. The determination is made based on the conversation where users direct words at each other (e.g., talk to each other) rather than based on words being directed to the computing device 102. The determination is made without any specific command to the computing device 102, such as a hot word, trigger word, or wake word being voiced by the user. Furthermore, the determination is made without any manual input (e.g., selection of a button or displayed menu option, input of a gesture on a touchscreen).

Demonstration mode refers to a mode of the computing device 102 in which features of the computing device 102 are highlighted or described. The demonstration mode is, for example, a mode that a computing device 102 is oftentimes placed in when the device is being displayed in a retail setting. In one or more embodiments, in demonstration mode a demonstration program is run that displays various demonstration mode content. The user may interact with the demonstration mode content but the operating system 108 restricts the user from accessing other programs or functionality of the computing device 102. Additionally or alternatively, the operating system 108 may allow the user to access other programs or functionality of the computing device 102.

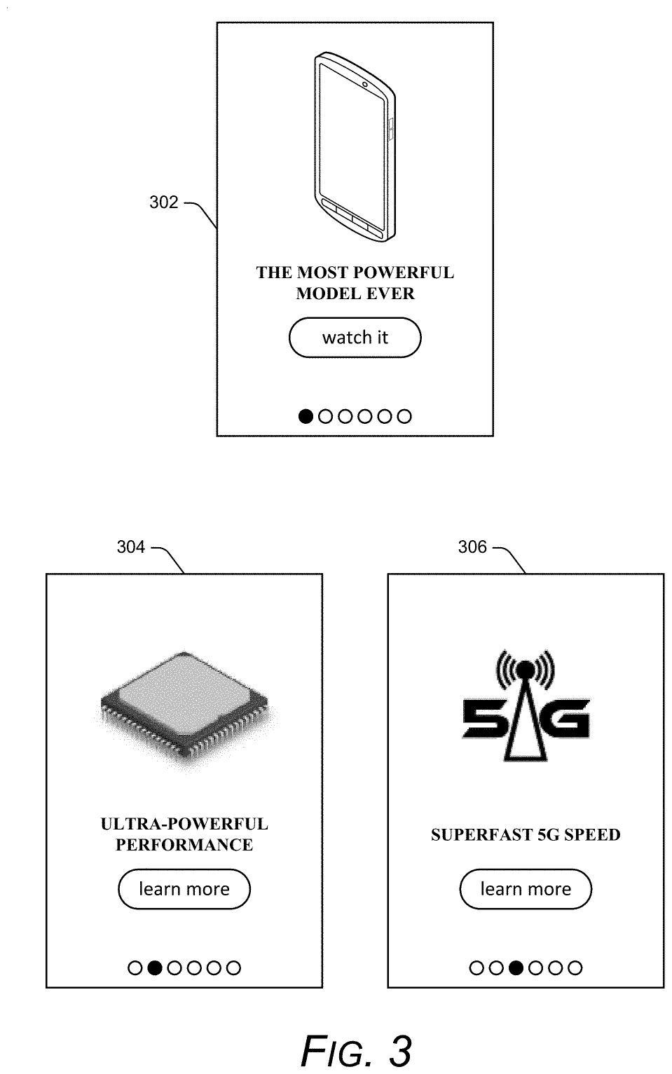

FIG. 3 illustrates an example of demonstration mode content. FIG. 3 illustrates three slides in a series of several slides that are displayed when running the demonstration program. In one or more embodiments, each slide in the series is displayed for a certain amount of time (e.g., five or ten seconds) and then the next slide in the series is displayed, looping back to the first slide in the series after the last slide has been displayed. Additionally or alternatively, user input may be received for the demonstration program to scroll backwards through the slides or forwards at a different rate (or to a particular slide by selecting the circle at the bottom corresponding to the desired slide).

A slide 302 is displayed including an image of the computing device (a mobile phone in this example) and a description indicating that the computing device is the most power model ever. A “watch it” button is included that is user-selectable to have the demonstration program play a video describing the computing device. A sequence of circles is included at the bottom to illustrate how many slides are in the series and which slide the slide 302 is. In the illustrated example, six circles indicate there are six slides and the first circle being filled in indicates that slide 302 is the first slide in the series of six slides.

A slide 304 is displayed including an image of a processor of the computing device and a description indicating that the processor provides ultra-powerful performance. A “learn more” button is included that is user-selectable to have the demonstration program display additional information describing the processor. The sequence of circles at the bottom indicates that slide 304 is the second slide in the series of six slides.

A slide 306 is displayed including an image of a tower and indication of 5G along with a description indicating that the computing device provides superfast 5G speed. A “learn more” button is included that is user-selectable to have the demonstration program display additional information describing the 5G capabilities of the computing device. The sequence of circles at the bottom indicates that slide 306 is the third slide in the series of six slides.

Returning to FIG. 2, the display mode determination module 202 determines whether the intent of a user is to have a secondary user assess or evaluate features of the computing device 102 based on the conversation included in audio input 204 in any of a variety of different manners. In one or more embodiments, display mode determination module 202 monitors audio input 204 for specific key words or key phrases indicating that the secondary user is requesting to assess or evaluate the features of the computing device 102, or indicating that the owner is requesting that the secondary user assess or evaluate the features of the computing device 102. Examples of such include “check this out,” “look at my new phone,” “you wanted to see this,” “can I look at it,” and so forth. The display mode determination module 202 determines the intent of the user is to have a secondary user assess or evaluate features of the computing device 102 in response to detecting any of these specific key words or key phrases in the audio input 204. It should be noted that the intent of the user can be the intent of one or all users in the conversation. Accordingly, the intent of the user can be the intent of the secondary user.

Additionally or alternatively, the display mode determination module 202 includes any of a variety of machine learning systems. Machine learning systems refer to a computer representation that can be tuned (e.g., trained) based on inputs to approximate unknown functions. In particular, machine learning systems can include a system that utilizes algorithms to learn from, and make predictions on, known data by analyzing the known data to learn to generate outputs that reflect patterns and attributes of the known data. For instance, a machine learning system can include decision trees, support vector machines, linear regression, logistic regression, Bayesian networks, random forest learning, dimensionality reduction algorithms, boosting algorithms, artificial neural networks, deep learning, and so forth.

The machine learning system receives the audio input 204 and classifies the audio input 204 as indicating an intent of a user is to have a secondary user assess or evaluate features of the computing device 102 or not an intent of a user is to have a secondary user assess or evaluate features of the computing device 102. The audio input 204 is optionally separated into multiple windows (e.g., 5-second or 10-second) windows of audio, optionally overlapping. The audio input 204 is encoded, such as by generating a vector representation of the audio input 204, and input to the machine learning system to generate the classification. In one or more embodiments, the display mode determination module 202 generates a vector representation of the audio input 204 by using any of a variety of public or proprietary techniques to convert the audio input 204 into text and generate a vector representation of the text. Additionally or alternatively, the display mode determination module 202 generates a vector representation of the audio input 204 by using any of a variety of public or proprietary techniques to generate other audio information in the audio input 204, such as a Mel Frequency Cepstral Coefficient (MFCC) that is an indication of which frequencies are present in each window (e.g., each 3-second window) of the audio input 204.

The machine learning system is trained by using training data that is audio data for conversations. Known labels are associated with the conversations in the audio data indicating whether each conversation indicates an intent of a user is to have a secondary user assess or evaluate features of the computing device 102. Vector representations for the training data are generated as discussed above. The machine learning system is trained by updating weights or values of layers in the machine learning system to minimize the loss between classifications, generated by the machine learning system for the training data, of whether an intent of a user is to have a secondary user assess or evaluate features of the computing device and the corresponding known labels for the training data. Various different loss functions can be used in training the machine learning system, such as cross entropy loss, hinge loss, and so forth.

In one or more implementations, the machine learning system included in display mode determination module 202 continues to be trained during use. For example, as audio input 204 is received and feedback indicating whether the audio input 204 indicates an intent of a user is to have a secondary user assess or evaluate features of the computing device 102, the machine learning system is further trained in the same manner as discussed above.

In one or more embodiments, in response to determining that the user intent is to have the secondary user assess the features of the computing device 102, the display mode determination module 202 retrieves demonstration mode content 206 from storage device 118. The demonstration mode content 206 is the content displayed by a demonstration program run by the operating system 108 when the computing device 102 is operating in the demonstration mode. Optionally, the demonstration mode content 206 is the demonstration program that the operating system 108 is to run. The display mode determination module 202 provides the demonstration mode content 206 to the operating system 108 as demonstration mode control 208.

Additionally or alternatively, in response to determining that the user intent is to have the secondary user assess the features of the computing device 102, the display mode determination module 202 provides as demonstration mode control 208 a signal or command for the operating system 108 to run in the demonstration mode. In response to the signal or command, the operating system 108 runs in demonstration mode, obtaining the demonstration mode content and demonstration program from storage device 118, from elsewhere in computing device 102, or from another device or service.

In one or more embodiments, while the operating system 108 is running the demonstration program other functionality (other than what is exposed by the demonstration program) is not available to the current user. Accordingly, the current user can interact with the demonstration program but the operating system 108 prevents the user from interacting with other functionality of the computing device 102.

In one or more embodiments, the demonstration program runs for a particular amount of time (e.g., 60 seconds) or until completion (e.g., all slides in the demonstration program have been displayed). After the particular amount of time elapses or the demonstration program is otherwise completed (e.g., as indicated by the operating system 108 or the demonstration program), the display mode determination module 202 automatically exits the demonstration mode, optionally notifying the operating system 108 that the demonstration mode has been exited. In such situations, after exiting the demonstration mode, other functionality of the computing device 102 is available to the current user of the computing device 102 (e.g., as it was prior to entering the demonstration mode). Additionally or alternatively, the display mode determination module 202 sends a lock signal or command to the operating system 108 to lock the computing device 102 upon exiting the demonstration program, preventing the current user from accessing other functionality of the computing device 102 unless the computing device 102 is unlocked.

Additionally or alternatively, the operating system 108 continues running the demonstration program until a current user of the computing device 102 changes to be the owner or a trusted user. In response to the current user of the computing device 102 changing to the owner or a trusted secondary user, the display mode determination module 202 provides an exit signal or command in demonstration mode control 208 in response to which the operating system 108 automatically exits the demonstration mode. Whether the current user is an owner or a trusted secondary user is determined as discussed below.

Additionally or alternatively, while in the demonstration mode the display mode determination module 202 continues receiving and analyzing the audio input 204 to determine whether a user intent is to have the computing device 102 exit the demonstration mode. In one or more embodiments this user intent is the intent of the owner of the computing device 102 (e.g., authenticated, such as by voice, as discussed below). In such situations, the display mode determination module 202 can monitor the audio input 204 for particular key words or key phrases, such as “thanks, I've seen enough,” or “here's your phone back.” Additionally or alternatively, the display mode determination module 202 can include a machine learning system similar to the machine learning system discussed above, but trained to determine whether or not the intent of the user is to have the computing device exit the demonstration mode rather than whether the intent of a user is to have a secondary user assess or evaluate features of the computing device. Similar to the discussion above, the determination of whether a user intent is to have the computing device 102 exit the demonstration mode is made based on a conversation where users direct words at each other (e.g., talk to each other) rather than based on words being directed to the computing device 102. The determination is made without any specific command to the computing device 102, such as a hot word, trigger word, or wake word being voiced by the user. Furthermore, the determination is made without any manual input (e.g., selection of a button or displayed menu option, input of a gesture on a touchscreen).

In one or more embodiments, device property values for the computing device 102 are user-configurable. The setting and changing of device property values on the computing device 102 can be controlled by the demonstration mode control system 116 or by another system or module of the computing device 102. The device property values refer to values or settings for any device properties involving the user interface of the computing device 102, such as display values, audio or sound values, interaction mode values, and so forth. The device property values are stored on the storage device 118 as user device property values 210.

Table I illustrates examples of device properties and their corresponding values. Although various device properties are included in Table I, additionally or alternatively a computing device 102 can have additional device properties or need not have all of the device properties included in Table I.

TABLE I

| Property | Values | Description |
|---|---|---|
| Brightness | Auto or between | Brightness of the device display |
| | min and max | |
| | values | |
| Dark | Off/On | Dark colored text on a light background (off) or |
| Theme | | light colored text on a dark background (on) |
| Night Light | Off/On | When on, reduces the amount of blue light |
| | | emitted by the device display to reduce eyestrain. |
| Adaptive | Off/On | When on, automatically adjusts the device display |
| Brightness | | brightness based on ambient light level. |
| Screen | An amount of | Turns off the device display after the amount of |
| Timeout | time | time elapses without user input to the device. |
| Auto | Off/On | Automatically rotates the screen between portrait |
| Rotate | | and landscape modes based on orientation of the |
| | | device. |
| Colors | Natural, | Changes the saturation of colors on the device |
| | Boosted, or | display, from a lowest of Natural to a highest of |
| | Saturated | Saturated. |
| System | Gesture, 2- | Changes the input style for navigating through |
| Navigation | button, or 3- | screens to be gesture only, 2 buttons, or 3 buttons. |
| | button | |
| Audio | Off/On | When on, allows various equalizer settings for |
| Effects | | audio to be set. |
| Media | Between min | Controls the volume of content output (e.g., |
| Volume | and max values | movies, video, audio in the web browser) by the |
| | | device. |
| Ring and | Between min | Controls the volume of the ring tone and |
| Notification | and max values | notification tone on the device. |
| Volume | | |

The user device property values 210 are initially set at default values, such as values that a developer, manufacturer, or seller of the computing device 102 determines to be typically or commonly used. User input is received that changes the default values, and user device property values 210 is updated to reflect these changes. Multiple sets of user device property values 210 are optionally maintained in the storage device 118, allowing different users (e.g., different owners or trusted secondary users of the computing device 102) to have different user device property values while they are the current user of the computing device 102.

In one or more embodiments, demonstration mode device property values 212 are also stored on the storage device 118. The demonstration mode device property values 212 are device property values that are expected (e.g., by a developer, manufacturer, or seller of the computing device 102) to best demonstrate the capabilities of the computing device 102. For example, the demonstration mode device property values 212 may include a high screen brightness and saturated colors to display a bright and vivid screen. The demonstration mode device property values 212 are, for example, the device property values that are typically set for the computing device 102 when the computing device 102 is being displayed in a retail setting.

In one or more embodiments, the display mode determination module 202 retrieves the demonstration mode device property values 212 as device property values 214 in response to determining that the user intent is to have the secondary user assess the features of the computing device 102. The display mode determination module 202 provides the retrieved device property values 214 to the operating system 108, which causes the operating system 108 to set the device properties for the computing device 102 to have the values as specified by the demonstration mode device property values 212. In response to subsequently exiting the demonstration mode, the display mode determination module 202 retrieves the user device property values 210 and provides the user device property values 210 to the operating system 108, which causes the operating system 108 to set the device properties for the computing device 102 to have the values as specified by the user device property values 210. This results in, for example, the operating system 108 returning to using the same user device property values 210 as were used just prior to changing to using the demonstration mode device property values 212.

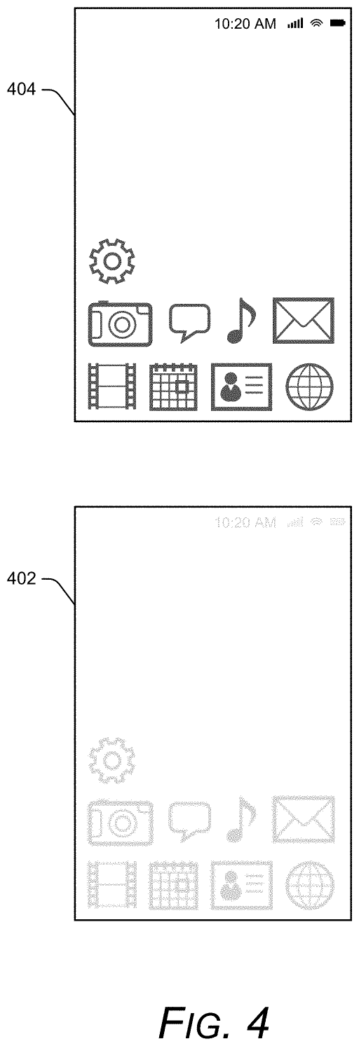

FIG. 4 illustrates an example of changing device property values. A screen 402 of a computing device 102 is illustrated including status indicators such as time, signal strength, and battery at the top. The screen 402 also includes icons at that represent applications or operating system programs that can be selected by the user for execution, such as a gear icon that represents a settings program (e.g., for user input of device property values), a camera icon that represents an image capture program, a speech balloon icon that represents a texting application, a music note icon that represents a music playback program, an envelope icon that represents an email application, a film strip icon that represents a video playback program, a calendar icon that represents a calendaring program, a business card icon that represents a contact list program, and a globe icon that represents a web browser.

In the illustrated example, assume the owner of the computing device 102 prefers the device display to have a lower brightness. Accordingly, the brightness device property value (from user device property values 210) for the owner is set to a low value, resulting in the icons being displayed at a low brightness level as illustrated by the screen 402 when the owner is using the computing device 102. However, if the computing device 102 enters the demonstration mode, the brightness device property value is changed to the demonstration mode device property values 212 that include a high screen brightness. This results in the icons being displayed at a high brightness level as illustrated by the screen 404 when the untrusted secondary user is the current user of the computing device 102. When the computing device 102 exists the demonstration mode, the brightness device property value is changed back to a low value, resulting in the icons again being displayed at a low brightness level as illustrated by the screen 402.

Returning to FIG. 2, in one or more embodiments the demonstration mode control system 116 also includes a current user detection module 216. The current user detection module 216 uses biometric information 218 obtained by the biometric information detection system 114 to determine whether the current user of the computing device 102 is the owner of the computing device 102, a trusted secondary user of the computing device 102, or an untrusted secondary user of the computing device 102. The secondary user is also referred to as a non-owner user. The owner of the device refers to a primary user of the device. The owner of the device typically is a user that has an account on the device and can log into the device (e.g., with a password, fingerprint identification, face identification, etc.). The owner of the device typically is, but need not be, the purchaser of the device (e.g., a company may pay for a device for an employee, and the employee is the primary user of the device and thus is referred to as the owner herein). The secondary user refers to another person that can use the device but need not, and typically does not, have an account on the device (and thus does not log into the device). The secondary user can be a trusted secondary user (e.g., a friend or family member of the owner of the device) or an untrusted secondary user (e.g., a new co-worker or acquaintance of the owner of the device).

This determination of whether the current user of the computing device 102 is the owner of the computing device 102, a trusted secondary user of the computing device 102, or an untrusted secondary user of the computing device 102 can be used to determine when to exit the demonstration mode as discussed above or whether to enter the demonstration mode as discussed in more detail below. The current user detection module 216 can make these determinations in different manners based on the biometric information 218.

For example, the biometric information detected by the biometric information detection system 114 is compared to authentication information previously provided by the owner or trusted secondary user of the computing device 102 to determine whether the biometric information matches the authentication information. Whether the biometric information matches the authentication information can be determined in different manners, such as determining whether the biometric information is the same as the authentication information, determining whether there is at least a threshold probability (e.g., 90%) that the biometric information and the authentication information identify the same user, and so forth. If the biometric information matches the authentication information for the owner, then the current user detection module 216 determines that the owner is the current user. If the biometric information matches the authentication information for a trusted secondary user, then the current user detection module 216 determines that a trusted secondary user is the current user. If the biometric information does not match the authentication information for the owner or a trusted secondary user, then the current user detection module 216 determines that an untrusted secondary user is the current user.

This authentication information can be provided to the computing device 102 in various manners. For example, for the owner of the computing device 102 the authentication information can be provided to the computing device 102 as part of a registration or login process. By way of another example, for a trusted secondary user of the computing device 102 the authentication information can be provided to the computing device 102 as the trusted secondary user uses the computing device 102. The authentication information is maintained by the computing device 102, such as in the storage device 118. By way of example, facial features, fingerprint features, or voice features of the owner of the computing device 102 can be obtained and stored as part of a registration process for the owner of the computing device 102. By way of another example, facial features, fingerprint features, or voice features of a trusted secondary user of the computing device 102 can be obtained and stored while the trusted secondary user is using the computing device 102.

A secondary user being a trusted secondary user refers to the secondary user being trusted by the owner of computing device 102. Whether a secondary user is a trusted secondary user can be determined in various manners. For example, the owner of the computing device 102 can provide any of various inputs (e.g., a gesture, a voice command, a button selection) indicating to the current user detection module 216 that the next user of the computing device 102 is a trusted secondary user. This allows the owner of the computing device 102 to determine which secondary users are trusted secondary users and which are not trusted secondary users. By way of another example, the current user detection module 216 can determine that any secondary user that uses the computing device 102 at least a threshold number of times (e.g., five times) or uses the computing device with at least a threshold frequency (e.g., five times within one month) is a trusted secondary user. In these situations the current user detection module 216 can assume that the secondary user is a trusted secondary user because the owner allows the secondary user to use the computing device 102 frequently.

By way of another example, the current user detection module 216 can determine that any secondary user that uses the computing device 102 and is in the owner's contacts or favorites list (e.g., maintained by the computing device 102) is a trusted secondary user. In this situation the current user detection module 216 can assume that the secondary user is a trusted secondary user because the owner has added the secondary user to the contacts list or favorites list.

In one or more embodiments, the current user detection module 216 analyzes facial features or voice features detected by the biometric information detection system 114. The biometric information detection system 114 can identify a single face in a current captured image and determine facial features for that single face, or can identify multiple faces in the current captured image and determine facial features for each of those multiple faces. Similarly, the biometric information detection system 114 can identify a single voice in captured audio and determine voice feature for that single voice, or can identify multiple voices in the captured audio and determine voice features for each of those multiple voices. The current user detection module 216 compares the facial features or voice features to authentication information previously provided by the owner or trusted secondary user to determine whether the facial features in any of the faces (or voice features in any of the voices) detected by the biometric information detection system 114 match (e.g., are the same as, have at least threshold probability (e.g., 90%) of identifying the same user) the authentication information.

If multiple matches are found between a face or voice in the current captured image and the authentication information for the owner or a trusted secondary user, then various different rules or criteria can be applied to determine whether the current user is the owner or is a trusted secondary user, or which of multiple trusted secondary users having authentication information matching faces or voices in the current captured image is the current user. In one or more embodiments, if the authentication information for the owner matches a face in the image or voice in the audio data, then the owner is determined to be the current user. However, if no faces in the image match and no voices in the audio data match the authentication information for the owner but a single face in the image or voice in the audio data matches the authentication information for a trusted secondary user, then the trusted secondary user matching the face or voice is the current user. Furthermore, if no faces in the image and no voice in the audio data match the authentication information for the owner but multiple faces in the image or multiple voices in the audio data each match the authentication information for a different trusted secondary user, then different rules are used to determine which of the different trusted secondary users is the current user, such as determining that the trusted secondary user that used the computing device 102 most recently is the current user, the trusted secondary user that used the computing device 102 most frequently or most times in the past is the current user, randomly or pseudorandomly selecting one of the trusted secondary users to be the current user, and so forth. If no faces in the image and no voice in the audio data match the authentication information for the owner or a trusted secondary user, then an untrusted secondary user is deemed to be the current user.

Additionally or alternatively, the current user detection module 216 analyzes other features detected by the biometric information detection system 114. Examples of these other features, as discussed above, include fingerprint features, aspects of voice captured by the computing device 102, touch features regarding how the user is touching or gripping the computing device 102, and so forth. The current user detection module 216 compares the detected features to authentication information previously provided by the owner or trusted secondary user to determine whether the detected features match the authentication information. For example, the current user detection module 216 compares the detected features (fingerprint features or aspects of voice captured by the computing device 102, or touch features regarding how the user is touching or gripping the computing device 102) to authentication information previously provided by the owner to determine whether the detected features match (e.g., are the same as, have at least threshold probability (e.g., 90%) of identifying the same user) the authentication information for the owner. If a match is found between the detected features and the authentication information for the owner, then the owner is deemed to be the current user. If a match is not found between the detected features and the authentication information for the owner but a match is found between the detected features and the authentication information for a trusted secondary user, then the trusted secondary user is deemed to be the current user. If a match is not found between the authentication information for the owner or a trusted secondary user, then an untrusted secondary user is deemed to be the current user.

It should be noted that in some situations the computing device 102 allows for multi-user login, which refers to different users having different credentials or accounts allowing them to log into the computing device 102. The secondary user discussed herein is different from a user in a multi-user login situation. The secondary user discussed herein need not log into the computing device 102, and typically does not have an account on the computing device 102 to log into (the computing device 102 does not maintain login credentials for the secondary user). Nonetheless, the secondary user is still able to use the computing device 102 after the owner has logged into or unlocks the computing device 102.

The current user detection module 216 uses the biometric information 218 to determine whether the current user of the computing device 102 is the owner, a trusted secondary user, or an untrusted secondary user as discussed above. The current user detection module 216 provides a user identification 220 to the display mode determination module 202 that identifies the current user of the computing device 102. This user identification 220 can take various forms, such as numbers, letters, or other characters. For example, the user identification 220 for the owner may be the value 1, the user identification 220 for any trusted secondary user may be the value 2, and the user identification 220 for an untrusted secondary user may be the value 0.

The display mode determination module 202 can use the user identification 220 to determine whether a user intent is to have a secondary user of the computing device 102 assess features of the computing device 102. In one or more embodiments, if the current user of the computing device 102 is the owner or a trusted secondary user, the display mode determination module 202 determines that the user intent is not to have a secondary user of the computing device 102 assess features of the computing device 102 regardless of the audio input 204. For example, in situations in which the current user of the computing device 102 is the owner or a trusted secondary user, the display mode determination module 202 need not analyze the audio input 204. By using the user identification 220 in determining user intent is to have a secondary user of the computing device 102 assess features of the computing device 102, the display mode determination module 202 avoids the situation where, due to audio input 204, the computing device 102 is automatically put in the demonstration mode but is being used by the owner or a trusted secondary user (which is presumably already familiar with the features of the computing device 102).

In one or more embodiments, the audio input 204 received by the demonstration mode control system 116 is analyzed by the display mode determination module 202 as discussed herein locally on the computing device 102. The audio input 204 may be used to determine whether to enter or exit the demonstration mode, and optionally further train a machine learning system of the display mode determination module 202, but can be done so locally at the computing device 102. The audio input 204 need not be transferred to another device or system (e.g., via the Internet) for processing. The audio input 204 is thus kept secure at the computing device 102 for a short period of time (just sufficient to perform the analysis discussed herein), avoiding the possibility of the audio input 204 from the user being used by another device or system, or being intercepted when communicated to another device or system.

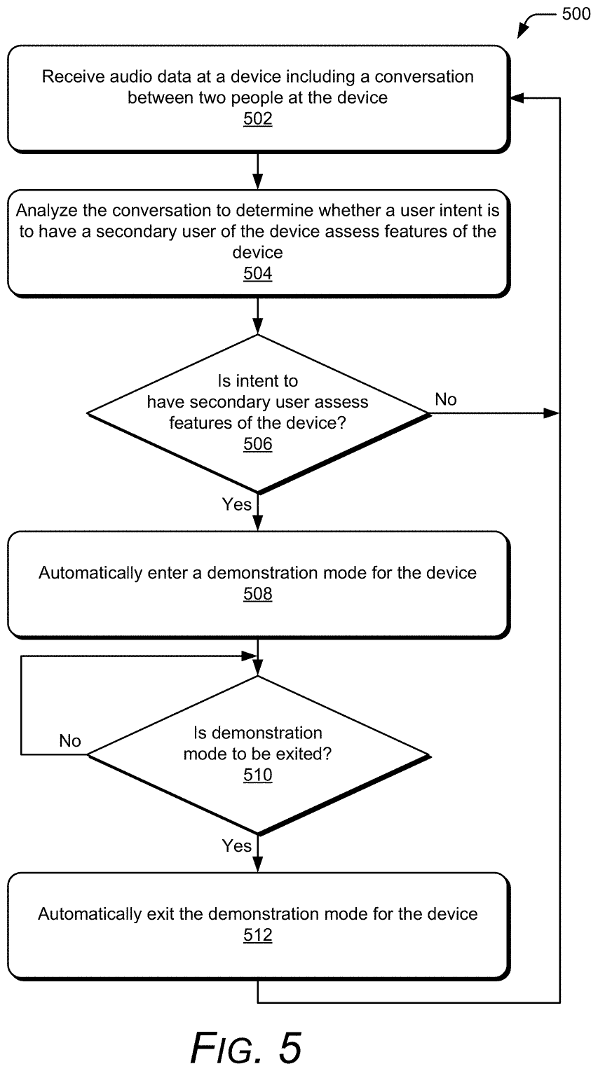

FIG. 5 illustrates an example process 500 for implementing the techniques discussed herein in accordance with one or more embodiments. Process 500 is carried out by one or more systems such as a demonstration mode control system of FIG. 1, and can be implemented in software, firmware, hardware, or combinations thereof. Process 500 is shown as a set of acts and is not limited to the order shown for performing the operations of the various acts.

In process 500, audio data is received at a device (act 502). The audio data is between two people present at the device, and is received, for example, via a microphone of the device.

The conversation in the audio data is analyzed to determine whether a user intent is to have a secondary user of the device assess features of the device (act 504). This analysis can be made in various manners as discussed above, such as identifying particular key words or key phrases in the conversation, classifying the conversation using a machine learning system, and so forth.

The process 500 proceeds based on whether it is determined that a user intent is to have a secondary user of the device assess features of the device (act 506). If it is determined that a user intent is not to have a secondary user of the device assess features of the device, the process 500 continues to receive audio data (act 502) and analyze the conversation in the audio data (act 504).

However, if it is determined that a user intent is to have a secondary user of the device assess features of the device, then a demonstration mode for the device is automatically entered (act 508). This demonstration mode includes, for example, running a demonstration program and setting device properties to demonstration mode device property values.

A check is made as to whether the demonstration mode is to be exited and the process 500 proceeds based on whether the demonstration mode is to be exited (act 510). If the demonstration mode is not to be exited, the device remains in the demonstration mode until a determination is made that the demonstration mode is to be exited.

If the demonstration mode is to be exited, then the demonstration mode is automatically exited (act 512). In one or more embodiments, the device returns to a regular or normal operation mode (e.g., the mode the device was in prior to entering the demonstration mode). The process returns to receive audio data (act 502) and analyze the conversation in the audio data (act 504).

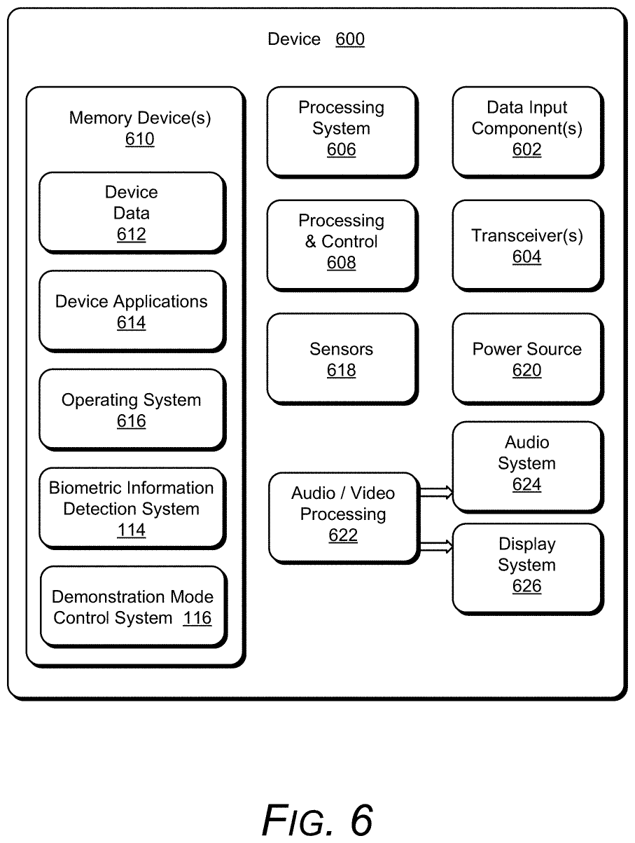

FIG. 6 illustrates various components of an example electronic device that can implement embodiments of the techniques discussed herein. The electronic device 600 can be implemented as any of the devices described with reference to FIGS. 1-5, such as any type of client device, mobile phone, tablet, computing, communication, entertainment, gaming, media playback, or other type of electronic device.

The electronic device 600 includes one or more data input components 602 via which any type of data, media content, or inputs can be received such as user-selectable inputs, messages, music, television content, recorded video content, and any other type of text, audio, video, or image data received from any content or data source. The data input components 602 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 602 may also include various other input components such as microphones, touch sensors, touchscreens, keyboards, and so forth.

The device 600 includes communication one or more transceivers 604 that enables one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 600 includes a processing system 606 of one or more processors (e.g., any of microprocessors, controllers, and the like) or a processor and memory system implemented as a system-on-chip (SoC) that processes computer-executable instructions. The processing system 606 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Additionally or alternatively, the device can be implemented with any one or combination of software, hardware, firmware, or fixed logic circuitry that is implemented in connection with processing and control circuits, which are generally identified at 608. The device 600 may further include any type of a system bus or other data and command transfer system that couples the various components within the device. A system bus can include any one or combination of different bus structures and architectures, as well as control and data lines.

The device 600 also includes computer-readable storage memory devices 610 that enable data storage, such as data storage devices that can be accessed by a computing device, and that provide persistent storage of data and executable instructions (e.g., software applications, programs, functions, and the like). Examples of the computer-readable storage memory devices 610 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory device 610 provides data storage mechanisms to store the device data 612, other types of information or data, and various device applications 614 (e.g., software applications). For example, an operating system 616 can be maintained as software instructions with a memory device and executed by the processing system 606. The device applications 614 may also include a device manager, such as any form of a control application, software application, signal-processing and control module, code that is native to a particular device, a hardware abstraction layer for a particular device, and so on.

In one or more embodiments the electronic device 600 includes a biometric information detection system 114 and a demonstration mode control system 116, described above. Although represented as a software implementation, one or both of the biometric information detection system 114 and the demonstration mode control system 116 may be implemented as any form of a control application, software application, signal processing and control module, firmware that is installed on the device 600, a hardware implementation of the modules, and so on.

The device 600 can also include one or more device sensors 618, such as any one or more of an ambient light sensor, a proximity sensor, a touch sensor, an infrared (IR) sensor, an accelerometer, a gyroscope, a thermal sensor, an audio sensor (e.g., microphone), a fingerprint sensor, an image sensor (e.g., a CCD sensor or a CMOS sensor), and the like. The device 600 can also include one or more power sources 620, such as when the device 600 is implemented as a mobile device. The power sources 620 may include a charging or power system, and can be implemented as a flexible strip battery, a rechargeable battery, a charged super-capacitor, or any other type of active or passive power source.

The device 600 additionally includes an audio or video processing system 622 that generates one or both of audio data for an audio system 624 and display data for a display system 626. In accordance with some embodiments, the audio/video processing system 622 is configured to receive call audio data from the transceiver 604 and communicate the call audio data to the audio system 624 for playback at the device 600. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for implementing automatically entering a demonstration mode for a device based on audio conversation have been described in language specific to features or methods, the subject of the appended claims is not necessarily limited to the specific features or methods described. Rather, the specific features and methods are disclosed as example implementations of techniques for implementing automatically entering a demonstration mode for a device based on audio conversation.

A method implemented in a computing device, the method comprising: receiving audio at the computing device, the audio including a conversation between at least two people present at the computing device; determining, by analyzing the conversation, whether a user intent is to have a secondary user of the computing device assess features of the computing device; and automatically entering, in response to determining that the user intent is to have the secondary user assess the features of the computing device, a demonstration mode for the computing device including running a demonstration program that highlights features of the computing device.

Alternatively or in addition to the above described method, any one or combination of the following. The at least two people comprising an owner of the device and the secondary user, and the determining comprising determining that the secondary user is requesting the computing device to assess the features of the computing device. The at least two people comprising an owner of the device and the secondary user, and the determining comprising determining that the owner of the computing device is requesting that the secondary user assess the features of the computing device. The determining comprising identifying one or more words or key phrases in the conversation directed two one of the at least two people rather than to the computing device. The determining comprising using a machine learning system trained to minimize a loss between classifications of whether an intent of a user is to have a secondary user assess features of the computing device generated by the machine learning system for training data and known labels corresponding to the training data. The entering the demonstration mode including changing device property values of the computing device to demonstration mode device property values that are expected to best demonstrate capabilities of the computing device. The demonstration mode device property values including one or more of display values, gesture values, and sound values. The method further comprising: determining, while in the demonstration mode, that a current user of the computing device has changed; and automatically exiting the demonstration mode in response to determining that the current user has changed. The method further comprising: receiving additional audio at the computing device while the computing device is operating in the demonstration mode, the additional audio including a conversation between the at least two people; determining, by analyzing the conversation from the additional audio, whether a user intent is to have the computing device exit the demonstration mode; and automatically exiting the demonstration mode in response to determining that the user intent is to have the computing device exit the demonstration mode.

A computing device comprising: a processor; a microphone; and a computer-readable storage medium having stored thereon multiple instructions that, responsive to execution by the processor, cause the processor to perform acts including: receiving, via the microphone, audio including a conversation between at least two people; determining, by analyzing the conversation, whether a user intent is to have a secondary user of the computing device assess features of the computing device; and automatically entering, in response to determining that the user intent is to have the secondary user assess the features of the computing device, a demonstration mode for the computing device including running a demonstration program that highlights features of the computing device.

Alternatively or in addition to the above described computing device, any one or combination of the following. The determining comprising identifying one or more words or key phrases in the conversation directed two one of the at least two people rather than to the computing device. The determining comprising using a machine learning system trained to minimize a loss between classifications of whether an intent of a user is to have a secondary user assess features of the computing device generated by the machine learning system for training data and known labels corresponding to the training data. The entering the demonstration mode including changing device property values of the computing device to demonstration mode device property values that are expected to best demonstrate capabilities of the computing device, the demonstration mode device property values including one or more of display values, gesture values, and sound values. The acts further including: determining, while in the demonstration mode, that a current user of the computing device has changed; and automatically exiting the demonstration mode in response to determining that the current user has changed. The acts further including checking whether the secondary user is a trusted secondary user, and the automatically entering including automatically entering the demonstration mode only if the secondary user is not the trusted secondary user.

An electronic device comprising: a microphone to receive audio including a conversation between at least two people; a storage device configured to store a demonstration program that highlights features of the electronic device; and a display mode determination module, implemented at least in part in hardware, configured to determine, by analyzing the conversation, whether a user intent is to have a secondary user of the electronic device assess features of the electronic device, and automatically enter, in response to determining that the user intent is to have the secondary user assess the features of the electronic device, a demonstration mode for the electronic device including running the demonstration program.

Alternatively or in addition to the above described electronic device, any one or combination of the following. The electronic device wherein to determine whether a user intent is to have a secondary user of the electronic device assess features of the electronic device is to identify one or more words or key phrases in the conversation directed two one of the at least two people rather than to the electronic device. The electronic device wherein to determine whether a user intent is to use a machine learning system trained to minimize a loss between classifications of whether an intent of a user is to have a secondary user assess features of the electronic device generated by the machine learning system for training data and known labels corresponding to the training data. The electronic device wherein to enter the demonstration mode is to includes to change device property values of the electronic device to demonstration mode device property values that are expected to best demonstrate capabilities of the electronic device, the demonstration mode device property values including one or more of display values, gesture values, and sound values. The electronic device wherein the demonstration mode determination module is further configured to: determine, while in the demonstration mode, that a current user of the electronic device has changed; and automatically exit the demonstration mode in response to determining that the current user has changed.

What is claimed is:

1. A method implemented in a computing device, the method comprising:
receiving audio at the computing device, the audio including a conversation between at least two people present at the computing device;
determining, by analyzing the conversation, whether a user intent is to have a secondary user of the computing device assess features of the computing device; and
automatically entering, in response to determining that the user intent is to have the secondary user assess the features of the computing device, a demonstration mode for the computing device including running a demonstration program that highlights features of the computing device.

2. The method of claim 1, the at least two people comprising an owner of the device and the secondary user, and the determining comprising determining that the secondary user is requesting the computing device to assess the features of the computing device.

3. The method of claim 1, the at least two people comprising an owner of the device and the secondary user, and the determining comprising determining that the owner of the computing device is requesting that the secondary user assess the features of the computing device.

4. The method of claim 1, the determining comprising identifying one or more words or key phrases in the conversation directed two one of the at least two people rather than to the computing device.

5. The method of claim 1, the determining comprising using a machine learning system trained to minimize a loss between classifications of whether an intent of a user is to have a secondary user assess features of the computing device generated by the machine learning system for training data and known labels corresponding to the training data.

6. The method of claim 1, the entering the demonstration mode including changing device property values of the computing device to demonstration mode device property values that are expected to best demonstrate capabilities of the computing device.

7. The method of claim 6, the demonstration mode device property values including one or more of display values, gesture values, and sound values.

8. The method of claim 1, further comprising:
determining, while in the demonstration mode, that a current user of the computing device has changed; and
automatically exiting the demonstration mode in response to determining that the current user has changed.

9. The method of claim 1, further comprising:
receiving additional audio at the computing device while the computing device is operating in the demonstration mode, the additional audio including a conversation between the at least two people;
determining, by analyzing the conversation from the additional audio, whether a user intent is to have the computing device exit the demonstration mode; and
automatically exiting the demonstration mode in response to determining that the user intent is to have the computing device exit the demonstration mode.

10. A computing device comprising:
a processor;
a microphone; and
a computer-readable storage medium having stored thereon multiple instructions that, responsive to execution by the processor, cause the processor to perform acts including:
receiving, via the microphone, audio including a conversation between at least two people;
determining, by analyzing the conversation, whether a user intent is to have a secondary user of the computing device assess features of the computing device; and
automatically entering, in response to determining that the user intent is to have the secondary user assess the features of the computing device, a demonstration mode for the computing device including running a demonstration program that highlights features of the computing device.

11. The computing device of claim 10, the determining comprising identifying one or more words or key phrases in the conversation directed two one of the at least two people rather than to the computing device.

12. The computing device of claim 10, the determining comprising using a machine learning system trained to minimize a loss between classifications of whether an intent of a user is to have a secondary user assess features of the computing device generated by the machine learning system for training data and known labels corresponding to the training data.

13. The computing device of claim 10, the entering the demonstration mode including changing device property values of the computing device to demonstration mode device property values that are expected to best demonstrate capabilities of the computing device, the demonstration mode device property values including one or more of display values, gesture values, and sound values.

14. The computing device of claim 10, the acts further including:
determining, while in the demonstration mode, that a current user of the computing device has changed; and
automatically exiting the demonstration mode in response to determining that the current user has changed.

15. The computing device of claim 10, the acts further including checking whether the secondary user is a trusted secondary user, and the automatically entering including automatically entering the demonstration mode only if the secondary user is not the trusted secondary user.

16. An electronic device comprising:
a microphone to receive audio including a conversation between at least two people;
a storage device configured to store a demonstration program that highlights features of the electronic device; and
a display mode determination module, implemented at least in part in hardware, configured to determine, by analyzing the conversation, whether a user intent is to have a secondary user of the electronic device assess features of the electronic device, and automatically enter, in response to determining that the user intent is to have the secondary user assess the features of the electronic device, a demonstration mode for the electronic device including running the demonstration program.

17. The electronic device of claim 16, wherein to determine whether a user intent is to have a secondary user of the electronic device assess features of the electronic device is to identify one or more words or key phrases in the conversation directed two one of the at least two people rather than to the electronic device.

18. The electronic device of claim 16, wherein to determine whether a user intent is to use a machine learning system trained to minimize a loss between classifications of whether an intent of a user is to have a secondary user assess features of the electronic device generated by the machine learning system for training data and known labels corresponding to the training data.

19. The electronic device of claim 16, wherein to enter the demonstration mode is to includes to change device property values of the electronic device to demonstration mode device property values that are expected to best demonstrate capabilities of the electronic device, the demonstration mode device property values including one or more of display values, gesture values, and sound values.

20. The electronic device of claim 16, wherein the demonstration mode determination module is further configured to:
determine, while in the demonstration mode, that a current user of the electronic device has changed; and
automatically exit the demonstration mode in response to determining that the current user has changed.
